(19) United States
(12) Patent Application Publication
(10) Pub. No.: US 2023/0402626 A1
(43) Pub. Date: Dec. 14, 2023

(54) FUEL CELL SYSTEM AND METHOD FOR OPERATING A FUEL CELL SYSTEM

(71) Applicant: Robert Bosch GmbH, Stuttgart (DE)

(72) Inventors: Jochen Wessner, Esslingen (DE); Martin Katz, Stuttgart (DE)

(21) Appl. No.: 18/030,550

(22) PCT Filed: Oct. 1, 2021
(86) PCT No.: PCT/EP2021/077137

§ 371 Date: Apr. 6, 2023

(30) Foreign Application Priority Data
Oct. 21, 2020 (DE) 10 2020 213 266.6

(51) Int. Cl. H01M 8/04111; H01M 8/04119

(52) U.S. Cl. CPC H01M 8/04111; H01M 8/04141

(57) ABSTRACT

The invention relates to a fuel cell system (1) comprising a fuel cell stack (2) with a cathode (3), to which air can be fed as cathode gas via a cathode gas path (4), an air compressor (5) being integrated in the cathode gas path (4). According to the invention, the cathode gas path (4) branches downstream of the air compressor (5) into a main path (4.1), which can be connected to an inlet (6) of the fuel cell stack (2), and into a secondary path (4.2), which can be connected to an outlet (7) of the fuel cell stack (2), wherein the main path (4.1) and the secondary path (4.2) can each be shut off individually or together with the aid of a shut off device (8). The invention also relates to a method for operating a fuel cell system (1).

### BACKGROUND

The invention relates to a fuel cell system. In addition, the invention relates to a method for operating a fuel cell system.

Fuel cells, for example a plurality of fuel cells of a fuel cell system connected to form a fuel cell stack, require for energy generation a) a fuel, as a rule hydrogen, which is fed via an anode gas path to an anode of the fuel cell stack, and b) oxygen, which is fed via a cathode gas path to a cathode of the fuel cell stack. Air taken from the environment is usually used as the oxygen supplier. Since the energy conversion process requires a certain air mass flow and a certain pressure level, the air fed on the cathode side is compressed beforehand by means of an air compressor arranged in the cathode gas path.

DE102004022312A1 discloses a moisture exchange module for moistening air fed to the cathode. In this way, the membrane can be protected against drying out and thus against damage or premature aging.

Such fuel cell systems, as shown in DE 102004022312 A1, have the disadvantage that the moistening device arranged in the cathode gas path requires a not inconsiderable installation space and is moreover expensive to procure. The present invention is therefore based on the object of specifying a fuel cell system which is of simpler design than this, in particular does not require a moistening device, so that installation space and costs can be saved.

To achieve the object, a fuel cell system and a method are proposed.

### SUMMARY

The proposed fuel cell system comprises a fuel cell stack with a cathode which can be fed with air as cathode gas via a cathode gas path. An air compressor is integrated into the cathode gas path. According to the invention, the cathode gas path branches downstream of the air compressor into a main path that can be connected to an inlet of the fuel cell stack and into a secondary path that can be connected to an outlet of the fuel cell stack, wherein the main path and the secondary path can each be shut off individually or together with the aid of a shut off device. Compressed air can thus be optionally fed to the inlet or to the outlet of the fuel cell stack. In addition, the air supply can be completely shut off in the event of a shutdown.

In order to supply the cathode with sufficient oxygen or air during normal operation of the fuel cell system, the air compressed with the aid of the air compressor is fed to the inlet of the fuel cell stack via the main path of the cathode gas path. The secondary path of the cathode gas path is shut off with the aid of the shut off device, and the air fed to the cathode is routed as usual through the fuel cell stack. By shutting off the main path and opening the secondary path, the air compressed with the aid of the air compressor can alternatively be fed to the outlet of the fuel cell stack. The compressed air thus enters the fuel cell stack via the outlet and exits again via the inlet. This means that the fuel cell stack is flowed through in the reverse direction. In the process, the air entrains product water, so that with the aid of the entrained product water the membranes of the fuel cells of the fuel cell stack are moistened. A moistening device in the cathode gas path can thus be omitted.

The switching between the main path and the secondary path can be controlled or regulated, for example, on the basis of a time sequence and/or depending on the water load of the cathode exhaust gas. In addition, operating modes are possible in which both the main path and the secondary path are kept open so that the air compressor does not have to operate against the shut off device. The flow direction through the fuel cell stack can be predetermined via the respectively open flow cross-section. Furthermore, in the case of a shutdown, both the main path and the secondary path can be shut off by means of the shut off device such that it is ensured that air is no longer fed to the cathode. This in turn allows the normally provided shut off valves to be omitted, so that further potential savings in terms of installation space and costs result.

In a development of the invention, it is proposed that the main path and/or the secondary path of the cathode gas path be connectable to a cathode exhaust gas path by means of the shut off device. The previously compressed air can be fed to the outlet of the fuel cell stack in a simple manner via the connection of the secondary path to the cathode exhaust gas path. To this end, the secondary path opens into the cathode exhaust gas path. In the case of the reverse flow direction through the fuel cell stack, the air exiting via the inlet of the fuel cell stack can be introduced into the cathode exhaust gas path via the connection of the main path to the cathode exhaust gas path. Preferably, therefore, the main path and the secondary path are always connected to the cathode exhaust gas path at the same time when the flow through the fuel cell stack is in the reverse flow direction in order to moisten the membranes. In other words, always when the main path of the cathode gas path is shut off with the aid of the shut off device.

Furthermore, it is proposed that the main path of the cathode gas path be connectable to a secondary path of the cathode exhaust gas path, and the secondary path of the cathode gas path be connectable to a main path of the cathode exhaust gas path. This ensures that different flow paths are available for the compressed air introduced into the cathode exhaust gas path via the secondary path of the cathode gas path and for the air introduced into the cathode exhaust gas path via the main path of the cathode gas path. This is because the flow direction is opposite.

According to a preferred embodiment of the invention, the cathode gas path as well as the cathode exhaust gas path thus each have a main path and a secondary path. That is to say, not only the cathode gas path but also the cathode exhaust gas path branch. This results in a tree-like structure of the flow paths. Which flow path is usable in each case can be controlled or regulated with the aid of the shut off device.

For this purpose, the shut off device preferably has movable shut off elements for shutting off the main path and the secondary path of the cathode gas path. In other words, the shut off device comprises at least two movable shut off elements. Further movable shut off elements are preferably arranged in the main path and in the secondary path of the cathode exhaust gas path. In this case, the shut off device comprises at least four movable shut off elements. The movable shut off elements can, for example, be in the form of flaps. In this way, the shut off device can be realized in a particularly cost-effective manner.

According to an advantageous embodiment of the shut off device, at least two shut off elements are arranged rotatably about a common axis of rotation. The shut off elements can thus be actuated together. So that a shut off element can be transferred into an open position and at the same time the other shut off element can be transferred into a shut off position, it is further proposed that the angular position of the shut off elements be offset by an angle α. The angle α can, for example, be 90°.

If the movable shut off elements are arranged not only in the main and secondary paths of the cathode gas path but also in the main and secondary paths of the cathode exhaust gas path, they will be arranged analogously, that is to say rotatably about a common axis of rotation and further preferably offset from one another in their angular position by an angle α. Furthermore, the axis of rotation can be the same axis of rotation about which the shut off elements are arranged rotatably for shutting off the main and secondary paths of the cathode gas path. This enables a particularly compact arrangement of the shut off elements of the shut off device and therefore particularly moderate requirements as regards installation space. Furthermore, all shut off elements can be controlled or actuated simultaneously.

In normal operation of the fuel cell system, the two main paths, i.e. the main path of the cathode gas path as well as the main path of the cathode exhaust gas path, are preferably open and the two secondary paths are in each case shut off by a movable shut off element of the shut off device. To reverse the flow direction in the fuel cell stack, the shut off device is actuated such that the two main paths are now shut off and the two secondary paths are open. For this purpose, the two shut off elements arranged in the secondary paths are moved from the shut off position into the open position. The two shut off elements arranged in the main paths are moved from the open position into the shut off position.

The shut off elements preferably have freewheels. The freewheels ensure that, in the event of a shutdown, the respectively open shut off elements can be transferred into a shut off position without the shut off elements already in the shut off position being opened. This means that for the complete shutting off of the air supply in the event of a shutdown, all shut off elements can be brought simultaneously into a shut off position.

Furthermore, it is proposed that the shut off device comprises at least two further movable shut off elements by means of which the inlet of the fuel cell stack and the outlet of the fuel cell stack can be shut off. The air supply to the cathode of the fuel cell stack can likewise be shut off with the aid of the further movable shut off elements. They thus increase safety in the event of a shutdown.

The two further movable shut off elements can be formed analogously to the previously described shut off elements, for example in the form of simple flaps. These can in turn be arranged rotatably about a common axis of rotation so that they can be actuated together. However, their angular position is preferably not mutually offset, since the two further movable shut off elements will be at the same time either in the shut off position or in the open position.

Preferably, the two further movable shut off elements are controllable independently of the previously described shut off elements. By means of the two further movable shut off elements, a bypass function can thus be realized at the same time, which enable the elimination of the bypass path and the bypass valve arranged therein. In this way, the fuel cell system can be further simplified.

The air compressor of the proposed fuel cell system has at least one compressor wheel, which is preferably arranged on a common shaft with a turbine wheel arranged in the cathode exhaust gas path. The air compressor can thus be operated particularly energy-efficiently since energy is recovered with the aid of the turbine wheel. As a result of the proposed use of product water, the turbine wheel is also protected against damage caused by droplet impact. This is because the product water is used to moisten the membranes of the fuel cells, so that significantly less or even no product water is discharged with the cathode exhaust gas.

In order to achieve the object mentioned at the outset, a method for operating a fuel cell system comprising a fuel cell stack with a cathode is also proposed. In the method, air which has been previously compressed by means of an air compressor is fed to the cathode in normal operation via a cathode gas path. According to the invention, the flow direction through the fuel cell stack of the air compressed by means of the air compressor is temporarily reversed for membrane moistening. In this way, the product water can be fed to a utilization which at the same time makes an additional moistening device in the cathode gas path unnecessary. In this way, the installation space requirement and the costs of the fuel cell system can be reduced.

To reverse the flow direction through the fuel cell stack, a main path of the cathode gas path connected to an inlet of the fuel cell stack is preferably shut off with the aid of a shut off device, and a secondary path of the cathode gas path connected to an outlet of the fuel cell stack is opened. This means that in particular the previously described fuel cell system according to the invention is suitable for carrying out the method according to the invention, since here the cathode gas path comprises a main path and a secondary path and also a shut off device for selectively shutting off the two paths. If both the main path and the secondary path can be shut off with the aid of the shut off device, in the event of a shutdown the air supply in the direction of the cathode can be completely shut off with the aid of the shut off device. The shut off device can thus replace at least one shut off valve so that the fuel cell system is further simplified.

A shut off device with movable shut off elements, for example in the form of flaps, is preferably used. The shut off device can thus be implemented in a space-saving manner and at the same time cost-effectively. The movable shut off elements are preferably arranged rotatably about at least one axis of rotation. The main path and/or the secondary path of the cathode gas path can thus be shut off by a rotational movement of the shut off elements. By means of a freewheel, it can be ensured that both the main path and the secondary path are shut off by the shut off elements, and this simultaneously.

### BRIEF DESCRIPTION OF THE DRAWINGS

The invention is explained in more detail below with reference to the accompanying drawings.

In the Drawings:

FIG. 1 shows a schematic representation of a cathode region of a fuel cell system,

FIG. 2 shows a schematic representation of a cathode region of a fuel cell system according to the invention during normal operation,

FIG. 3 shows a schematic representation of the cathode region of the fuel cell system of FIG. 2 when the flow direction through the fuel cell stack is reversed,

FIG. 4 shows a schematic representation of the cathode region of the fuel cell system of FIG. 1 in the case of a shutdown, and

FIG. 5 shows a schematic representation of a cathode region of a second fuel cell system according to the invention.

### DETAILED DESCRIPTION

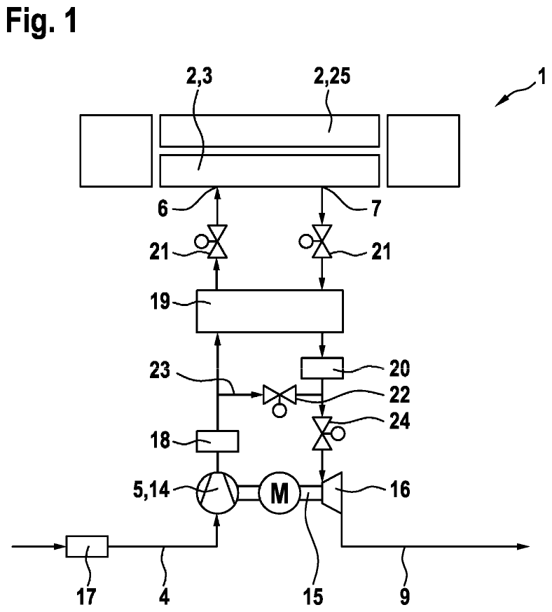

FIG. 1 shows a fuel cell system 1 comprising a fuel cell stack 2 with a cathode 3 and an anode 25. Air can be fed to the cathode 3 via a cathode gas path 4. The air is taken from the environment, routed through an air filter 17 and compressed with the aid of an air compressor 5 arranged in the cathode gas path 4 and driven by an electric motor. Since the air is heated during compression, it is cooled before an inlet 6 of the fuel cell stack 2 with the aid of a cooling device 18 arranged in the cathode gas path 4 downstream of the air compressor 5. The previously compressed and cooled air is also moistened with the aid of a moistening device 19 arranged downstream of the cooling device 18. Moistening should prevent drying out of the membranes of the fuel cells of the fuel cell stack 2. Although water accumulates in the fuel cells during the energy conversion process, it cannot prevent the membranes from drying out since it is discharged from the fuel cell stack together with the depleted gases.

The cathode exhaust gas is introduced into a cathode exhaust gas path 9 via an outlet 7 of the fuel cell stack 2 and fed to an exhaust gas turbine arranged in the cathode exhaust gas path 9. The exhaust gas turbine has a turbine wheel 16 which is arranged on a shaft 15 with a compressor wheel 14 of the air compressor 5. The exhaust gas turbine into which the cathode exhaust gas flows thus supports the electromotive drive of the air compressor 5. Since the cathode exhaust gas entrains product water, and water droplets contained in the cathode exhaust gas can lead to damage to the exhaust gas turbine (“droplet impact”), a water separator 20 is arranged in the cathode exhaust gas path 9 upstream of the exhaust gas turbine.

In the fuel cell system 1 shown in FIG. 1, the cathode gas path 4 and the cathode exhaust gas path 9 can each be shut off via a shut off valve 21. Closing the shut off valves 21 is intended to prevent air continuing to be fed to the cathode 3 of the fuel cell stack 2 in the event of a shutdown. The cathode gas path 4 and the cathode exhaust gas path 9 can be briefly closed via a bypass path 23 with a bypass valve 22 arranged herein in order to bypass the fuel cell stack 2. In addition, a pressure regulator 24 is arranged in the cathode exhaust gas path 9 upstream of the exhaust gas turbine.

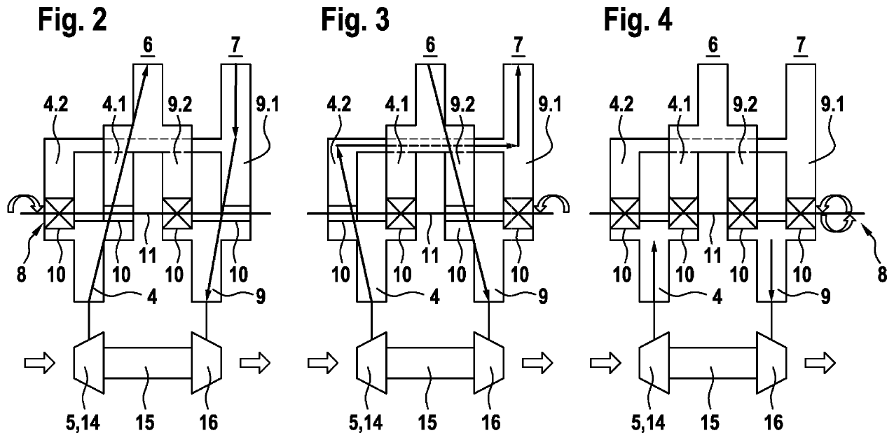

The invention is explained below by way of example with reference to FIG. 2 to 5.

The highly simplified schematic representation of FIG. 2 shows an air compressor 5 with a compressor wheel 14, which is arranged on a shaft 15 together with a turbine wheel 16 of an exhaust gas turbine. The compressor wheel 14 is arranged in a cathode gas path 4 via which air compressed with the aid of the air compressor 5 can be fed to an inlet 6 of a fuel cell stack (not shown). The turbine wheel 16 is arranged in a cathode exhaust gas path 9 and is flowed through by cathode exhaust gas which leaves the fuel cell stack via an outlet 7. The cathode gas path 4 and the cathode exhaust gas path 9 branch so that the cathode gas path 4 and the cathode exhaust gas path 9 each form a main path 4.1, 9.1 and a secondary path 4.2, 9.2. This results in a tree-like structure of the flow paths.

Movable shut off elements 10 of a shut off device 8 are arranged in the main paths 4.1, 9.1 and in the secondary paths 4.2, 9.2, wherein in the present case, they are simple flaps which are arranged rotatably about a common axis of rotation 11. The angular position of the shut off elements 10 of the main paths 4.1, 9.1 is in each case offset by an angle α to the angular position of the shut off elements 10 of the secondary paths 4.2, 9.2 so that either the main paths 4.1, 9.1 or the secondary paths 4.2, 9.2 can be shut off.

FIG. 2 shows the position of the shut off elements 10 in normal operation of the fuel cell system 1. In normal operation, the main paths 4.1, 9.1 are in each case open and the secondary paths 4.2, 9.2 shut off. The air compressed by means of the air compressor 5 is thus fed to the inlet 6 via the main path 4.1 of the cathode gas path 4. The depleted air or the cathode exhaust gas reaches the turbine wheel 16 (see arrows indicating the flow direction) via the outlet 7 and the main path 9.1 of the cathode exhaust gas path 9.

In FIG. 3, the position of the shut off elements 10 has been changed by actuating the shut off device 8. To do so, the shut off elements 10 designed as flaps were rotated (see side arrow in the direction of rotation). The shut off elements 10 in each case now free the secondary paths 4.2, 9.2, while the main paths 4.1, 9.1 are shut off (see arrows indicating the flow direction). Since the secondary path 4.2 of the cathode gas path 4 opens into the main path 9.1 of the cathode exhaust gas path 9.1, the air compressed by means of the air compressor 5 is now fed to the outlet 7 of the fuel cell stack. The fuel cell stack is thus flowed through in the reverse direction. The air entrains product water so that a membrane moistening is realized with the aid of the product water. The air routed through the fuel cell stack for membrane moistening exits the fuel cell stack via the inlet 6 and can be discharged via the main path 4.1 of the cathode gas path 4 into the secondary path 9.2 of the cathode exhaust gas path 9.

FIG. 4 shows a further position of the shut off elements 10 of the shut off device 8 for the case of a shutdown. In this position, all shut off elements 10 assume the same angular position so that all main paths 4.1, 9.1 and all secondary paths 4.2, 9.2 are shut off. The air supply is thus completely interrupted.

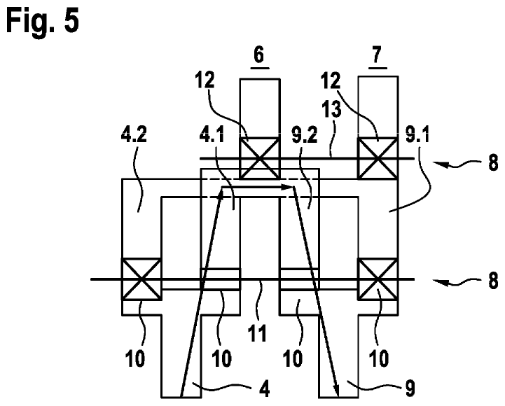

FIG. 5 shows a development of the fuel cell system 1 of FIGS. 2 to 4. Here, the shut off device 8 comprises further shut off elements 12 in the form of flaps which are arranged rotatably about a common axis of rotation 13, specifically in the same angular position. With the aid of the further shut off elements 12, the inlet 6 and the outlet 7 can be shut off such that the air supply is reliably interrupted in the event of a shutdown. Furthermore, the further shut off elements 12 can be closed and the shut off elements 10 can be open in the main path 4.1 of the cathode gas path 4 and in the secondary path 9.2 of the cathode exhaust gas path 9. In this way, the shut off device 8 enables a bypass operation (see arrows indicating the flow direction) and is thus capable of replacing a bypass path 23 having a bypass valve 22 arranged therein analogous to FIG. 1.

1. A fuel cell system (1) comprising a fuel cell stack (2) with a cathode (3) to which air can be fed as cathode gas via a cathode gas path (4), wherein an air compressor (5) is integrated into the cathode gas path (4),
wherein the cathode gas path (4) branches downstream of the air compressor (5) into a main path (4.1) that can be connected to an inlet (6) of the fuel cell stack (2) and into a secondary path (4.2) that can be connected to an outlet (7) of the fuel cell stack (2), wherein the main path (4.1) and the secondary path (4.2) can each be shut off individually or together with a shut off device (8).

2. The fuel cell system (1) according to claim 1,
wherein the main path (4.1) and/or the secondary path (4.2) of the cathode gas path (4) can be connected to a cathode exhaust gas path (9) with the shut off device (8).

3. The fuel cell system (1) according to claim 2,
wherein the main path (4.1) of the cathode gas path (4) can be connected to a secondary path (9.1) of the cathode exhaust gas path (9), and the secondary path (4.2) of the cathode gas path (4) can be connected to a main path (9.1) of the cathode exhaust gas path (9).

4. The fuel cell system (1) according to claim 1,
wherein the shut off device (8) has movable shut off elements (10) for shutting off the main path (4.1) and the secondary path (4.2) of the cathode gas path.

5. The fuel cell system (1) according to claim 4,
wherein at least two shut off elements (10) are arranged rotatably about a common axis of rotation (11).

6. The fuel cell system (1) according to claim 5,
wherein the shut off elements (10) have freewheels, such that they can be transferred into a same angular position.

7. The fuel cell system (1) according to claim 1,
wherein the shut off device (8) comprises at least two further movable shut off elements (12) by which the inlet (6) of the fuel cell stack (2) and the outlet (7) of the fuel cell stack (2) can be shut off.

8. The fuel cell system (1) according to claim 7,
wherein the further shut off elements (12) are arranged rotatably about a common axis of rotation (13).

9. The fuel cell system (1) according to claim 1,
wherein the air compressor (5) has at least one compressor wheel (14) which is arranged on a common shaft (15) with a turbine wheel (16) arranged in the cathode exhaust gas path (9).

10. A method for operating a fuel cell system (1), comprising a fuel cell stack (2) with a cathode (3) to which, in normal operation, air compressed with an air compressor (5) is fed via a cathode gas path (4),
wherein a flow direction through the fuel cell stack (2) of the air compressed with the air compressor (5) is temporarily reversed for membrane moistening.

11. The method according to claim 10,
wherein in order to reverse the flow direction with a shut off device (8), a main path (4.1) of the cathode gas path (4) connected to an inlet (6) of the fuel cell stack (2) is shut off and a secondary path (4.2) of the cathode gas path (4) connected to an outlet (7) of the fuel cell stack (2) is opened.

12. The method according to claim 10,
wherein a shut off device (8) with movable shut off elements (10, 12) is used.

13. The fuel cell system (1) according to claim 4, wherein the movable shut off elements (10) are flaps.

14. The fuel cell system (1) according to claim 4, wherein further movable shut off elements (10) are arranged in the main path (9.1) and in the secondary path (9.2) of the cathode exhaust gas path (9).

15. The fuel cell system (1) according to claim 5, wherein an angular position of the shut off elements (10) is offset by an angle (α).

16. The fuel cell system (1) according to claim 15, wherein the angle (α) is 90°.

17. The fuel cell system (1) according to claim 8, wherein the further shut off elements (12) are arranged rotatably about the common axis of rotation (13) in a same angular position.

18. The method according to claim 12, wherein the movable shut off elements (10, 12) are flaps, which are arranged rotatably about at least one axis of rotation (11, 13).
